(19) United States
(12) Patent Application Publication
(10) Pub. No.: US 2012/0066648 A1
(43) Pub. Date: Mar. 15, 2012

(54) MOVE AND TURN TOUCH SCREEN INTERFACE FOR MANIPULATING OBJECTS IN A 3D SCENE

(75) Inventors: Robert John Rolleston, Rochester, NY (US); Jeffrey David Kingsley, Macedon, NY (US); Paulo Goncalves de Barros, Worcester, MA (US)

(73) Assignee: XEROX CORPORATION, Norwalk, CT (US)

(21) Appl. No.: 12/881,638

(22) Filed: Sep. 14, 2010

(51) Int. Cl. G06F 3/048; G06F 3/041; G06F 3/033

(52) U.S. Cl. 715/849; 715/863; 345/173

(57) ABSTRACT

Methods and a system for manipulating objects in a 3D virtual scene are disclosed. Two different mechanisms are used for a user interface, including a first hand and a second hand of a user. The first hand manipulates translational manipulation of the virtual object, such as displacement of the object in three orthogonal planes. The second hand manipulates rotational manipulation of the object. While the interface uses and recognizes different hands for manipulation of the object, it also uses three digits or fingers of different hands to control height, speed, translational and rotational movements.

### BACKGROUND

The exemplary embodiment relates to fields of graphical user interfaces. It finds particular application in connection with the provision of a user interface for manipulating objects within a three-dimensional virtual scene. However, a more general application can be appreciated with regard to image processing, image classification, image content analysis, image archiving, image database management and searching, and so forth.

Many conventional user interfaces, such as those that include physical pushbuttons, are inflexible. This may prevent a user interface from being operable by either an application running on the portable device or by users. When coupled with the time consuming requirement to memorize multiple key sequences and menu hierarchies, and the difficulty in activating a desired pushbutton, such inflexibility can be inefficient.

For electronic devices that display a three-dimensional virtual space on the touch screen display, present user interfaces for navigating in the virtual space and manipulating three-dimensional objects in the virtual space are too complex and cumbersome. These problems are exacerbated on portable electronic devices because of their small screen sizes.

Accordingly, there is a need for electronic devices with touch screen displays that provide more transparent and intuitive user interfaces for navigating in three-dimensional virtual spaces and manipulating three-dimensional objects in these virtual spaces. Such interfaces increase the effectiveness, efficiency and user satisfaction with such devices

### BRIEF DESCRIPTION

Methods and apparatus of the present disclosure provide exemplary embodiments for a user interface system that manipulates three-dimensional virtual objects, such as objects within a virtual scene, for example. The three-dimensional objects are manipulated by displacing and/or rotating them in various directions within a touch screen interface using at least two different hands. For example, a virtual scene or environment provided in a touch screen display can have a plurality of objects and a user may desire to manipulate particular objects within the display. The touch screen display interacts with the user by detecting different mechanisms (e.g., different hands, or extensions/portions of each hand and associated gestures or movement) for interfacing, such as a left and a right hand, in order to enable fast manipulation of the objects.

In one embodiment, a memory is coupled to a processor of a computer device that has a touch screen display for generating images. The display is configured to display a perspective view of a three-dimensional virtual scene with three-dimensional virtual object located among a plurality of virtual objects at a touch screen interface that controls the objects. The interface comprises a translational engine that processes inputs from the first mechanism (e.g., an index finger or the like) and translates inputs, such as a first movement from the first mechanism into a translational movement of the object. A rotational engine processes inputs from a second mechanism and translates the inputs from the second mechanism, such as a second movement into a rotational movement of the object.

In another embodiment, the first mechanism includes a first digit and/or a second digit of a first hand of the user, and the second mechanism includes at least one digit of a second hand of the user. Thus, three digits (e.g., a right index finger, thumb and left index finger) may be detected for manipulating virtual objects to a desired position and/or location within a virtual three-dimensional scene.

In another embodiment, the interface includes a physics component that determines the amount of physical constraints the object is subjected to. One example is the simulation of gravity when no virtual objects in the scene support the object and the touch screen interface receives no input. Other physicals constraints of interactions are also possible, such as the response to collisions with other objects in the virtual scene.

In another embodiment, a method for a user interface system to manipulate virtual objects in a three-dimensional scene of a display that is executed via a processor of a computer with a memory storing executable instructions for the method is provided. The method comprises receiving a first touch from a hand as input on a touch screen interface surface. The first touch selects a virtual object from among a plurality of virtual objects. The touch is made with a first portion of a first hand of a user, for example. A first hand motion across the surface moves the object in a first plane. Input by a second hand by a second touch that is outside a distance from the first touch is detected. Input is received at the touch screen interface surface of the computer that is a second hand motion from the second hand that causes rotation of the virtual object based on a direction of the second hand motion.

### BRIEF DESCRIPTION OF THE DRAWINGS

FIG. 1 is a functional block diagram of a user interface system according to embodiments herein;

FIG. 2 is a representation of a user interface screen according to embodiments herein; and

FIG. 3 is a flowchart detailing an exemplary method for displacing objects within a three-dimensional virtual scene.

### DETAILED DESCRIPTION

Aspects of the exemplary embodiment relate to a system and methods for manipulating the spatial relationship and placement of objects relative to one another within a virtual display. This can be an inherent part of many applications ranging from managing a kitting or fulfillment pack to video games or orchestrating simulations of warfare, or the like. Three different modalities of operation were designed, built, and tested in order to formulate techniques to manipulate objects in a virtual scene using a touch screen interface. Research results indicate that a multi-hand interface performed better in terms of time compared with other interfaces.

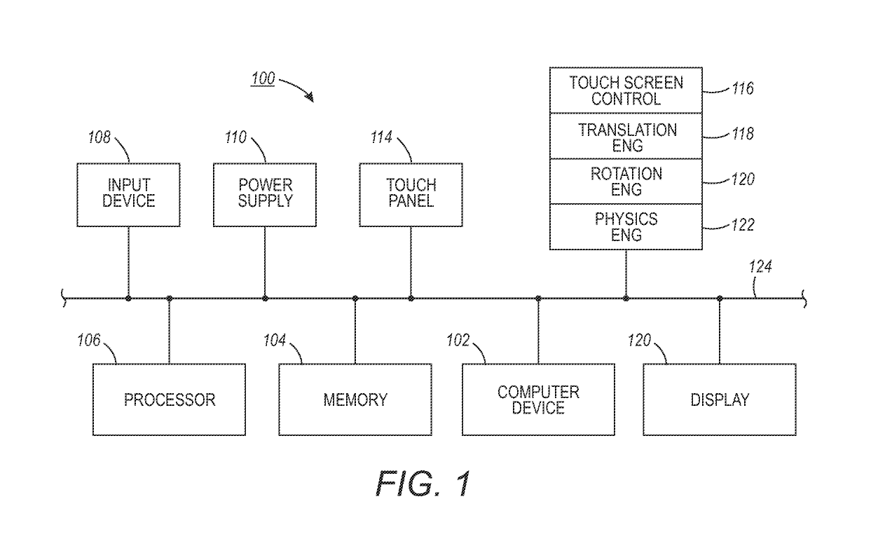

FIG. 1 illustrates one embodiment of an exemplary user interface and control system 100 for displacing three-dimensional virtual objects from a plurality of virtual objects. A client device, such as a computer device 102 comprises a memory 104 for storing instructions that are executed via a processor 106. The system 100 may include an input device 108, a power supply 110, a display 112 and/or a touch screen interface panel 114. The system 100 may also include a touch screen control 116 having a translational engine 118, a rotational engine 120 and/or a physics component 122. The system 100 and computer device 102 can be configured in a number of other ways and may include other or different elements. For example, computer device 102 may include one or more output devices, modulators, demodulators, encoders, and/or decoders for processing data.

A bus 124 permits communication among the components of the system 100. The processor 106 includes processing logic that may include a microprocessor or application specific integrated circuit (ASIC), a field programmable gate array (FPGA), or the like. The processor 106 may also include a graphical processor (not shown) for processing instructions, programs or data structures for displaying a graphic, such as a three-dimensional scene or perspective view.

The memory 104 may include a random access memory (RAM) or another type of dynamic storage device that may store information and instructions for execution by the processor 106, a read only memory (ROM) or another type of static storage device that may store static information and instructions for use by processing logic; a flash memory (e.g., an electrically erasable programmable read only memory (EEPROM)) device for storing information and instructions, and/or some other type of magnetic or optical recording medium and its corresponding drive.

The touch screen panel accepts touches from a user that can be converted to signals used by the computer device 102, which may be any processing device, such as a personal computer, a mobile phone, a video game system, or the like. Touch coordinates on the touch panel 114 are communicated to touch screen control 116. Data from touch screen control 116 is passed on to processor 106 for processing to associate the touch coordinates with information displayed on display 112.

Input device 108 may include one or more mechanisms in addition to touch panel 114 that permit a user to input information to the computer device 100, such as microphone, keypad, control buttons, a keyboard, a gesture-based device, an optical character recognition (OCR) based device, a joystick, a virtual keyboard, a speech-to-text engine, a mouse, a pen, voice recognition and/or biometric mechanisms, etc. In one implementation, input device 108 may also be used to activate and/or deactivate the touch screen interface panel 114.

The computer device 102 can provide the 3D graphical user interface as well as provide a platform for a user to make and receive telephone calls, send and receive electronic mail, text messages, play various media, such as music files, video files, multi-media files, games, and execute various other applications. The computer device 102 performs operations in response to the processing logic of the touch screen control 116. The translational engine 118 executes sequences of instructions contained in a computer-readable medium, such as memory 104, which interpret user input at the touch screen panel 114 as translational input. For example, a user's hand may touch an object in the touch panel 114 to select an object, and thereby, activate the object for manipulation. The rotational engine 120 recognizes a user input from a different hand, for example, and executes sequences of instructions to interpret user input at the touch screen panel 114 as rotational input for rotating a selected object.

The physics engine or component 122 executes a sequence of instructions to implement natural physics in a virtual scene to varying degrees, such as for applying gravity or collision detection and response in a perspective view being displayed. For example, if an object is displaced via the translational engine 120 in mid air without support of any virtual object/structure in the scene, the object can be made to fall under the forces of gravity being implemented in the scene via the physics engine 122. The physics of gravity can be applied to varying degrees as well. In one example, the object may be left to float and slowly fall down to the closest supporting surface within the virtual screen. Other embodiments are also envisioned herein, such as the object being made to float, or dropping rapidly due to increased gravity forces being applied or the object stops when colliding with other objects, or can push the other objects out of the way. Alternatively, objects can be made to pass through other objects in a virtual scene. Thus, the virtual scene can comprise differing physics that are applied to different objects therein, or to all the objects of the scene, which differ or are the same as actual physical properties of known physics.

Instructions executed by the engines 118, 120 and/or 122 may be read into memory 104 from another computer-readable medium. In alternative embodiments, hard-wired circuitry may be used in place of or in combination with software instructions to implement operations described herein. Thus, implementations described herein are not limited to any specific combination of hardware circuitry and software.

Touch screen control 116 may include hardware and/or software for processing signals that are received at touch screen panel 114. More specifically, touch screen control 116 may use the input signals received from touch screen panel 114 to detect a touch by a dominant or a first hand as well as a movement pattern associated with the touches so as to differentiate between touches. For example, the touch detection, the movement pattern, and the touch location may be used to provide a variety of user inputs for interacting with a virtual object (not shown), which is displayed in the display 112 of the device.

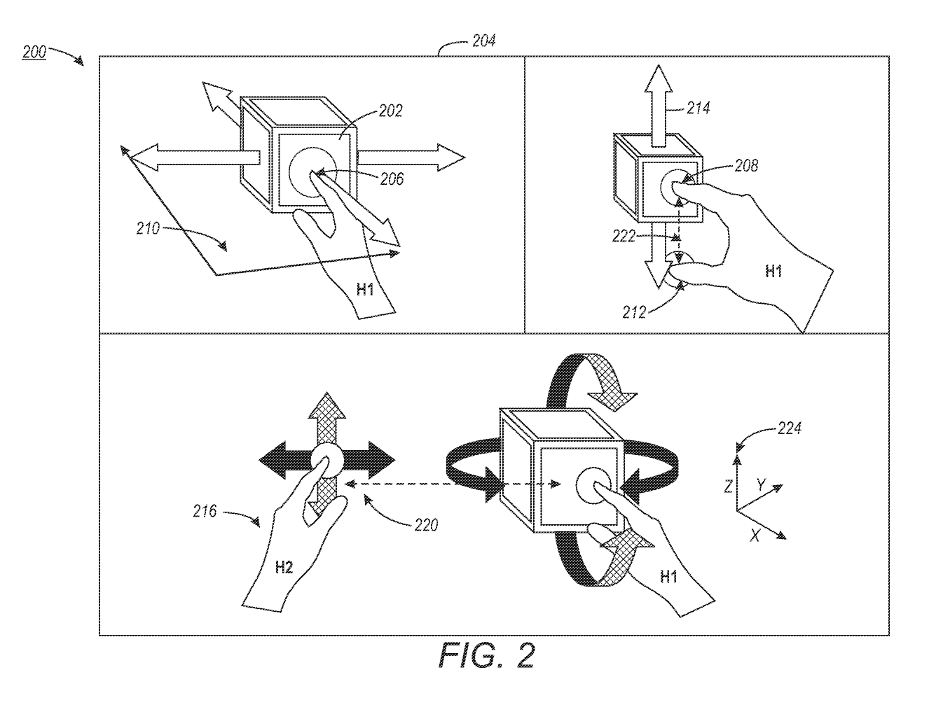

FIG. 2 illustrates an exemplary aspect of a user interface 200 for manipulating objects in a display with a touch screen interface surface. An object 202 is illustrated within a display 204 having the user interface 200 operatively coupled to a processor (not shown), such as a graphical processor or the like, and is operable as a touch screen interface. The display 204 provides virtual scenes having three-dimensional objects therein. For example, the object 202 may be a three-dimensional virtual box, as illustrated, or may be any other object that is rendered graphically in the display.

A user interacts with the object 202 via the user interface 200 in order to displace the object 202 in a desired manner. The user interface 200 allows for interaction between the object 202 and first and second mechanism 208, 216 (e.g., a first and second hand) via a touch screen interface surface 206 of the display 204.

The interface 200 processes input that is received at the touch screen interface surface 206 via interaction commands that are identified and distinguished from each other by the amount of fingers and their spatial relationship on the screen. Three fingers are used to implement this interface: two fingers from one hand and one finger from the other. For example, the fingers used, as illustrated in FIG. 2, were the index (H1index) and thumb (H1thumb) fingers from the dominant hand and the index finger from the non-dominant hand (H2index). Although two hands are illustrated with digits or fingers used for interfacing, this disclosure is not limited to any particular mechanism, and other limbs, hands, digits or extensions thereof for contacting the touch screen may also be envisioned.

In one embodiment, touching the object 202 with a first mechanism 208 selects and holds the object. A mechanism can be anything capable of interfacing with the touch screen interface surface that provides input on the display, such as a left or right hand, a digit or finger, a portion of a hand or an extension of the user, such as a physical object, or the like.

Physical forces and responses such as gravity, momentum, and friction are taken into account in the user interface 200 to varying degrees. For example, releasing the first mechanism 208 (e.g., releasing a portion of a user's hand, or the like) from the touch screen interface surface 206 releases and drops the object 202. In another embodiment, the object may float when the user ceases to interact or release touch at the touch screen surface 206 until the user interacts with the object again. Alternatively, the object drifts slowly or rapidly depending upon the strength of gravity forces the user interface 200 is set for. In another example, if the object is moved into contact with a second object in the scene, the first selected object may stop against the second object, push the second object aside, or pass thru the second object. In another example, if the selected object is on motion when it is released, it may continue in motion, or have forces such as friction and momentum control its subsequent travel within the scene.

In addition, a second mechanism 216 (e.g., a second hand, left/right hand, or the like) controls the rotation of the selected object 202 that is being held and activated by the first mechanism (e.g., a different hand). A second movement, such as sliding the index finger of the second mechanism horizontally, rotates the selected object 202 around the vertical axis. Sliding the finger vertically rotates the selected object around the horizontal axis.

In order for the user interface 200 to recognize the second mechanism 216 interacting with the object, the second mechanism, such as a second hand of the user, touches the touch screen interface surface 206 at a certain distance 220 located away from the object 202 or from where the first mechanism 208 activated the object 202 for manipulation. The distance 220 for recognizing the second mechanism 216 may vary, but is approximately outside of a hand distance, such as four to six inches (e.g., five inches) from where the first mechanism 208 or hand digit activated the object 202 by touching it. The present disclosure is not limited to any specific distance, and can be any set distance envisioned by one of ordinary skill in the art that is less or more than examples provided herein. Recognizing the second mechanism 216 outside of the distance 220 enables the user interface to recognize two different mechanisms for interaction, such as a left and a right hand. Faster interfacing capability is therefore achieved by the user interface 200 for manipulating three-dimensional virtual objects.

A third mechanism 212 is also recognized when touched to the touch screen interface surface 206 within the distance 220 discussed and proximate to where the first mechanism 208 activated the object 202 for displacement.

In one embodiment, a first motion, such as sliding the first mechanism across the surface 206, translates the object on a horizontal plane 210 that intersects the current object height 214. The height of the object, for example, is controlled by varying a distance 222 between the first mechanism 208 and a third mechanism 212, such as different digit or finger of the same hand as the first mechanism. For example, where the first mechanism 208 is an index finger of a right hand (e.g., H1index), the third mechanism 212, such as a thumb of the same right hand, controls the height 214 when they are both touching the screen. As the first and third mechanisms are separated from one another, the object 202 displaces in height accordingly and corresponding in velocity in which the separation of mechanisms occur at the surface 206. In other words, as an index finger and thumb, for example, move apart, the object 202 that has been activated displaces along the height 214 path of a plane or height direction. The velocity may be set or may be mapped to the velocity of movement between the index and thumb of a right hand, for example.

In one embodiment, the variation of the distance 222 between these two mechanisms or digits of a hand is mapped to an increment or decrement in the height and/or speed of the object 202. For example, touching both of these fingers on the touch screen interface surface 206, then increasing the distance between them, and then holding the fingers in that position moves the selected object 202 up, for example, at a constant speed. The object's height displacement can then be stopped by releasing the third mechanism (e.g., H1thumb, or other like mechanical means) from the screen surface 206; alternatively, by returning the fingers to a distance value equivalent to the one when the fingers first touched the screen.

The separation of the mechanisms 208 and 212 can provide a means to control height along a z-axis or height plane that is substantially perpendicular to the horizontal plane 210. Height displacement of the object along the height 214 may be mapped together or separate with the velocity of displacement, as discussed above. For example, where the displacement is mapped together with speed, an index finger and thumb increasing or decreasing distance between them at the screen surface will displace the object 202 along the height 214 and will also displace the object corresponding to the rate in which the two digits (index and thumb fingers) are separated or brought together.

In another embodiment, separation of different mechanisms 208 and 212 can be in a different plane than what is shown in FIG. 2. For example, instead of the height 214 direction, a separation of digits on a user's hand could be mapped to a depth in which the object is displaced within a scene; alternatively, other three-dimensional directions or paths may be mapped to the separation or combining of first and third mechanisms, as described herein.

Further, the user interface recognizes the third mechanism 212 as distinct from the first mechanism 208 and the second mechanism 216 when the user touches the third mechanism 212 on the touch screen interface surface 206 within the certain distance 220. The distance may be any practical distance for distinguishing on the surface from the first and second mechanisms and is not limited to any particular measured distance.

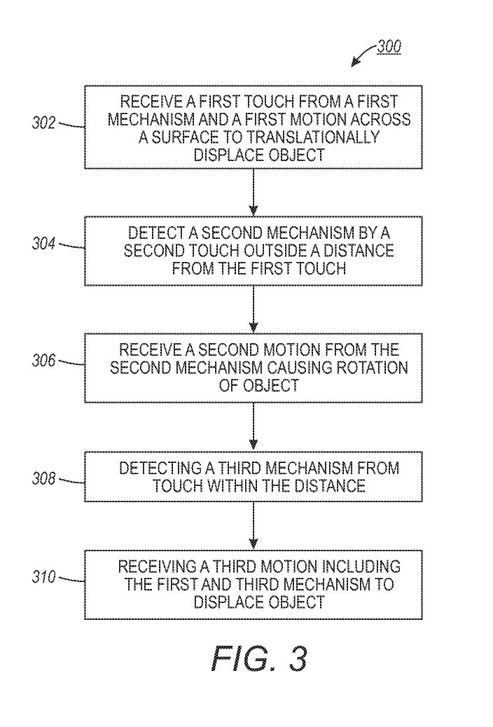

An example methodology 300 for a user interface system 200 is illustrated in FIG. 3. While the method 300 is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

At 302, a touch screen interface surface 206 of a computer 102 receives as input a first touch that selects a virtual object 202 from a first portion of a first hand 208 of a user. The interface surface 206 also receives a first hand motion that moves the object 202 in a first plane 210.

At 304, a second hand 208 is detected as input from a second touch that is located outside a certain distance 220 from the first touch. The touch screen interface surface 206 receives input from a second hand and recognizes the second hand as a rotational control for the object selected. The second hand can be any mechanism outside of the distance from where the object was selected and can be a finger of a second hand or some other portion thereof capable of touching the surface 206. Further, the second may be the same or a different hand from the first hand 208 of a user. For example, if the interface is programmed with a gravity control to float the object, the second hand may be the same hand after it is lifted off of the interface and then put back onto the interface outside the distance 220 for rotational control. An advantage of using two hands at once, however, can be for rapid manipulation and displacement of objects in a three-dimensional virtual realm or scene. This could increase a user's dexterity in simulations, such as in game combat scenarios or skill based gaming scenarios. The method 300, however, is not limited to any one particular application and could be implemented in a wide variety of applicable fields.

At 306, the touch screen interface surface 206 receives as input a second hand motion from the second hand 216 that causes rotation of the virtual object based on a direction in which the hand moves.

At 308, input from a third mechanism is received. The third mechanism can be a third hand or a different second portion 212 of the first hand, for example. The user interface 200 recognizes the third hand 212 from a touch within the distance 220 at the touch screen interface surface 206.

At 310, the touch screen interface surface 206 receives as input a third hand motion from the third hand or from a different portion of the first hand 212 that causes the object 202 to move in a plane perpendicular to a horizontal plane 210, such as in a second plane that is a height plane. The third hand motion includes the separation and/or combining together of the first hand 212 and the third hand/different portion of the first hand 212. Input receives from the third motion changes a velocity and/or a height in which the object 202 is displaced.

In one embodiment, physical forces and responses such as a virtual gravity effect is applied when the user interface 200 is not detecting a touch on the surface by the mechanisms the user implements for interfacing touch and motion. For example, once contact to the interface surface is removed, an object(s) selected could be left to drop down with gravity until another object or structure within the virtual realm supports it; alternatively, the gravity effect could be minimized to allow the object(s) to float when no supporting virtual structure is present in the virtual scene. In other embodiments, other physical forces such as collisions with other objects, momentum, and friction may affect the subsequent position and velocity of the object within the scene.

In another embodiment, the translation or displacement along an x, y or z axis 224 or in three orthogonal directions is complimented with shadows and/or lines being projected. Shadows and/or lines projected from the object 202 onto three orthogonal planes can provide a relative position. Rendering of real-world conditions of the object within a virtual scene with the object(s), such as shadowing or outline projection, can more realistically indicate the position of the object, a direction in which the object 202 is displaced and provide visual aid to the user at the same time.

The method(s) illustrated may be implemented in a computer program product that may be executed on a computer or on a mobile phone in particular. The computer program product may be a tangible computer-readable recording medium on which a control program is recorded, such as a disk, hard drive, or may be a transmittable carrier wave in which the control program is embodied as a data signal. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, transmission media, such as acoustic or light waves, such as those generated during radio wave and infrared data communications, and the like, or any other medium from which a computer can read and use.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, or PAL, or the like. In general, any device, capable of implementing a finite state machine that is in turn capable of implementing the flowchart shown in the figures, can be used to implement the method for displacing and/or manipulating virtual objects.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for a user interface system for manipulating objects executed via a processor of a computer with a memory storing executable instructions for the method, comprising:
providing a virtual three-dimensional object that is manipulated by a user via the processor of the computer;
detecting at a touch screen interface of the computer a primary mechanism that interacts with the virtual object by a first movement for a first manipulation, which comprises sensing the primary mechanism touch the object at the touch screen interface; and
detecting at the touch screen interface a secondary mechanism that interacts with the virtual object by a second movement for a second manipulation, wherein detecting the secondary mechanism includes sensing the secondary mechanism touch the interface at a distinct distance from where the primary mechanism touches the object.

2. The method of claim 1, comprising:
upon the primary mechanism touching the object at the touch screen interface, activating the object to be manipulated translationally and rotationally by the primary mechanism and the secondary mechanism respectively.

3. The method of claim 1, comprising:
detecting a third mechanism located within the distinct distance from the primary mechanism, and manipulating the object at a velocity and/or a height of displacement for the object that changes depending upon movement of the first mechanism and the third mechanism together and/or separate from one another.

4. The method of claim 3, comprising:
sensing the first movement for the first manipulation and displacing the object by a translational manipulation across the interface, wherein the translational manipulation comprises displacing the object along a first two dimensional plane or displacing the object along a second two dimensional plane, depending upon movement of the primary mechanism and the third mechanism.

5. The method of claim 1, comprising:
displacing the object by the first movement with the first mechanism along a first plane of the interface or a second plane, wherein the first plane defines displacement of the object within a vertical plane with respect to the interface, and the second plane defines displacement of the object within a horizontal plane that is substantially perpendicular to the vertical plane.

6. The method of claim 1, wherein detecting the secondary mechanism occurs concurrently with detecting the primary mechanism, the second manipulation comprises a rotational manipulation of the object, the first manipulation comprises a translational manipulation of the object, the primary mechanism includes two different digits of a first hand and the secondary mechanism includes one digit of a second hand of the user, wherein the two digits manipulate a distance of movement corresponding to a distance of separation between the two digits.

7. The method of claim 1, comprising:
upon not detecting input from the first mechanism including a first hand of the user and/or the second mechanism including a first hand of the user, applying a virtual gravity effect causing the object to drop in the scene when no virtual objects are supporting the object.

8. The method of claim 7, comprising:
rotating the object from up to down, from down to up, from left to right, from right to left or diagonally depending upon a direction of the first movement on the interface by the second mechanism.

9. A user interface and control system for displacement of a three-dimensional virtual object from a plurality of virtual objects, comprising:
a memory coupled to a processor of a computer device;
a display configured to display a perspective view of a virtual scene with the object located among the plurality of virtual objects;
a touch screen interface for controlling the object comprising:
a translational engine that processes inputs from a first mechanism and translates the inputs from the first mechanism into a translational movement of the object; and
a rotational engine that processes inputs from a second mechanism and translates the inputs from the second mechanism into a rotational movement of the object;
wherein the first mechanism includes a first digit and a second digit of a first hand of the user, and the second mechanism includes at least one digit of a second hand of the user.

10. The system of claim 9, comprising:
a physics engine that determines an amount of gravity the object is subjected to when no virtual objects in the scene support the object and the touch screen interface receives no input.

11. The system of claim 9, wherein the translational movement comprises a movement of the object in a vertical plane with respect to the perspective view of the scene and a horizontal plane that is substantially perpendicular to the vertical plane.

12. The system of claim 9, wherein a distance between the first digit and the second digit on the touch screen interface corresponds with a velocity and/or a height of displacement for the object.

13. A method for a user interface system to manipulate virtual objects in a three-dimensional scene of a display that is executed via a processor of a computer with a memory storing executable instructions for the method, comprising:
receiving as input at a touch screen interface surface of the computer a first touch that selects a virtual object of a plurality of virtual objects from a first portion of a first hand of a user and a first hand motion across the surface that moves the object in a first plane by the first portion;
detecting input by a second hand by a second touch that is outside a distance from the first touch; and
receiving as input at the touch screen interface surface of the computer a second hand motion from the second hand that causes rotation of the virtual object based on a direction of the second hand motion.

14. The method of claim 13, comprising:
detecting input by a third hand or by a different second portion of the first hand touching the touch screen interface surface within the distance from the first touch.

15. The method of claim 14, comprising:
receiving as input at the touch screen interface surface a third hand motion from the third hand or by a different portion of the first hand that causes the object to move in a second plane perpendicular to the first plane and at a velocity and/or height, which changes depending upon movement of the first portion and the third hand moving together and/or separate from one another, or which changes depending upon movement of the first portion and the different second portion moving together and/or separate from one another.

16. The method of claim 14, upon not detecting input from the first portion of the first hand, the second hand, and the second portion of the first hand or the third hand, applying a virtual gravity effect causing the object to drop in the scene when no virtual objects are supporting the object.

17. The method of claim 14, upon not detecting input from the first portion of the first hand, the second hand, and the second portion of the first hand or the third hand, floating the object in the scene when no virtual objects are supporting the object.

18. The method of claim 13, wherein detecting input by the second hand occurs concurrently to detecting input by the first portion of the first hand and/or a second portion of the first hand.

19. The method of claim 13, translating the object in three orthogonal directions, where a relative position of the object is projected onto three orthogonal planes by use of shadows or lines.

20. The system of claim 9, comprising:
a physics engine that determines collision responses of the object when colliding with another object, the responses including at least one of causing the object to stop or bounce off upon contact with the another object, push the another object aside, and pass through the another object and/or that determines momentum and friction responses of the object when sliding along a surface, the responses including at least one of causing the object to stop immediately when it is released, continue motion indefinitely, and coming to a gradual stop simulating the effects of friction.
